(19) United States
(12) Patent Application Publication
(10) Pub. No.: US 2020/0124165 A1
(43) Pub. Date: Apr. 23, 2020

(54) DEVICE AND METHOD FOR SELECTING GEARS IN MOTOR VEHICLES

(71) Applicant: Küster Holding GmbH, Ehringshausen (DE)

(72) Inventors: Andreas LOTZ, Asslar-Berghausen (DE); Thomas SCHMIDT, Ehringshausen (DE)

(73) Assignee: Küster Holding GmbH, Ehringshausen (DE)

(21) Appl. No.: 16/623,808

(22) PCT Filed: Jun. 22, 2018
(86) PCT No.: PCT/EP2018/066775

§ 371 Date: Dec. 18, 2019

(30) Foreign Application Priority Data
Jun. 29, 2017 (DE) 10 2017 114 593.1

(51) Int. Cl. F16H 59/02; B60W 50/16; B60W 30/19; F16H 61/02

(52) U.S. Cl. CPC F16H 59/0217; F16H 59/0204; F16H 59/105; B60W 30/19; F16H 61/0204; B60W 50/16

(57) ABSTRACT

A device and method for selecting gears in motor vehicles has an operating element selecting the respective gear, which operating element is manually pivotable or rotatable with respect to at least one axis of rotation, a haptic feedback for a user being generable by means of an actuator acting upon the operating element, and a control unit generating gear control signals and actuating the actuator depending on the position of the operating element. The device has a simpler design that can be controlled with little complexity. The different gears are associated with different shifting thresholds of the operating element for switching to a different gear.

### CROSS-REFERENCE TO RELATED APPLICATIONS

This application is a national stage application (under 35 USC § 371) of PCT/EP2018/066775, filed Jun. 22, 2018, claiming priority to DE 10 2017 114 593.1, filed Jun. 29, 2017, the contents of each of which are incorporated by reference herein.

### BACKGROUND OF THE INVENTION

### Technical Field and State of the Art

The invention relates to a device for selecting gear stages in motor vehicles.

Until a few years ago, it was common in vehicles with automatic transmissions to transmit both the desired transmission gear stage and the engagement of the parking brake from the shift actuator to the transmission manually, for example via cables.

The trend toward shift-by-wire systems has already taken hold in the current vehicle generations. The driver's request to engage the gear stages or the parking brake is transmitted to actuators in or on the transmission only electronically. Said actuators receive the signals and take over the work of shifting.

Continuative concepts of the shift mechanism should in the future be able to offer the so-called driver's workplace even more possibilities for individualization.

An actuating device for a shift-by-wire-actuated change gear transmission is known from DE 10 2009 000 640 A1. The actuating device comprises a shifter base and a selector lever pivotably mounted in a bearing position of the shifter base. An actuator is provided to block the selector lever. In addition to the blocking function, the actuator is designed to produce mechanical vibrations or oscillations.

An actuating device for a change gear transmission comprising an actuating lever and a position sensor for determining the position of the actuating lever is known from EP 2 318 736 B1. The actuating device further comprises a haptic emulation for a realistic emulation of the counterforces acting on the actuating lever. For this purpose, a controllably adjustable electrorheologically or magnetorheologically adjustable damper connected to the actuating lever and also an actuator are provided.

A haptic shift mechanism comprising a selector lever is known from EP 1 490 610 B1, wherein the selector lever can be moved within a pattern possessing boundaries and is blocked off from areas outside the boundaries of the pattern. Furthermore, at least one sensor for detecting a position of the selector lever and for outputting said position is provided. An actuator outputs a force to the selector lever.

U.S. Pat. No. 4,949,119 describes a device and a method for simulating gear stage changes in a vehicle with a selector lever and position sensors.

DE 10 2005 060 933 B3 describes a selector lever for a motor vehicle, which is mounted in a housing via a first and a second axle that are spatially separated from one another, extend perpendicular to one another and are respectively displaceable in axial direction. The shift movement of the selector lever is thus converted into two translatory movements that extend perpendicular to one another.

Known from DE 10 2005 001 589 B3 is a shift mechanism for a vehicle transmission comprising a selector lever for the selection of gear stages, which is pivotable about at least one axis of rotation and is disposed within a shift mechanism housing. At its lower free end, the selector lever is disposed on a blocking element of a locking device. Locking is always necessary when a change in the position of the selector lever is not compatible with other underlying data of the status of motor vehicle components, such as the pedals and the engine speed.

A manual transmission comprising an adjusting element for changing the gear ratio and a manually actuatable operating element, by means of which the adjusting element can be moved into positions assigned to different gears, is known from DE 198 48 191 A1. To replicate a conventional manual transmission, a damper arrangement is provided, which has at least one damping device that is coupled to the operating element and by means of which the operating resistance of the operating element can be set. Each damping device is associated with a restoring device that is connected in parallel and by means of which restoring forces can be exerted on the operating element.

A rotary actuator for electrical or electronic devices in a motor vehicle, which comprises an adjusting element that is rotatable relative to fixed housing parts, is known from US 2006/0012584 A1, WO 2013/123375 A2, WO 2015/088630 A1 and DE 10 2006 007 600 B4 respectively. Such rotary actuators can, for example, be used to control the volume, the air conditioning, the heater, as well as the mirrors and/or the seat or the sunroof, or the navigation system, the vehicle status or websites.

DE 10 2006 028 228 A1 describes an actuator used as an actuating mechanism for an electrical switch having a movable handle and a pivoting means. Such an electrical switch is intended to be used as a gear selector switch for a motor vehicle. The actuator can be disposed in an electrical and/or electronic switch in the form of a joystick or a cursor switch.

An operating device having a handle that can be manually deflected out of a rest position relative to an axis is known from EP 2 737 380 B1. Also provided are a sensor system for detecting the deflection of the handle and a haptic device, by means of which the handle is subjected to haptic feedback in dependence of the deflection of the handle. The handle is fixedly connected to an actuator, by means of which it is driven a movement distance in an alternately movable manner in dependence of its deflection.

U.S. Pat. No. 8,347,748 B2 describes a gear selection device comprising a selector lever. Sensors are used to measure the movement of the selector lever. The device further comprises electric motors, which are connected to the selector lever.

Overall, the devices of the state of the art have the disadvantage that their structure is very complex, and a large number of components are necessary to realize the individual sub-functions. On the other hand, the functional scope of the simply designed devices is limited.

Based on the above-described disadvantages, an object of the invention is to provide an improved device for selecting gear stages that has a simpler design and can be controlled with less effort than the state of the art.

### SUMMARY OF THE INVENTION

A device for selecting gear stages in motor vehicles has an operating element which selects the respective gear stage and is configured to be manually pivotable or rotatable with respect to at least one axis of rotation, wherein haptic feedback for a user can be produced by means of an actuator that acts upon the operating element.

Further provided is a control system, which actuates the actuator and generates gear stage control signals in dependence of the position of the operating element. The different gear stages are associated with different shifting thresholds of the operating element for shifting into another gear stage.

This ensures that shifting into a different gear stage is reliable when the user changes the gear stage manually. Shifting from a first into a second gear stage thus takes place at a different position of the operating element than shifting from the second gear stage into the first. There is therefore always the existence of a particular state and, if the operating element is located at the transition between two adjacent positions that are assigned to different gear stages, a so-called transient oscillation between two selectable gear stages is avoided.

The invention relates to an operating element that is movable in X and/or Y direction for example, for example in the form of a rotary knob or a joystick, the force feedback of which is freely programmable. The torque or force of the operating element is provided by at least one actuator. In contrast to the current mechanical concepts, in which the force characteristics always follow the predefined detent, this system allows the shifting travel and the shifting forces to be adjusted according to the individual requirements of the manufacturer or the driver. The same system can thus be used to describe a monostable selector lever, a locking shifter or even a manual H-shifter by changing the parameters. Even the often costly implementation of right-hand drive variants is easy to realize with this system.

Consequently, for example, the underlying idea allows the provision of one universal selector lever for a variety of vehicle or customer-specific operating concepts.

In addition to the mentioned advantages, the device according to the invention also offers new functions; detent forces can be changed as a function of the condition, for example, or the driver can be alerted with feedback in the event of impermissible shifting states. The operating element can furthermore be adjusted to the gear position automatically during autonomous driving.

According to an advantageous further development of the invention the operating element can be configured for manual actuation by the user and also for an automatic shift movement by the actuator actuated by the control system.

In the context of the present invention, an actuator is a drive element that can convert a control signal into a mechanical movement or function as a brake.

The device according to the invention has the advantage that, even in the case of a gear stage change not initiated by the user, for example in autonomous driving mode, in an automatic mode of the transmission, for an automatic engagement of the parking brake or a shift paddle operation, the position of the operating element that can be seen or felt by the user corresponds to the currently engaged gear stage. The control system of the device receives a signal containing the information about the currently engaged gear stage from another control device of the vehicle, for example from the transmission controller or the controller responsible for autonomous driving, the shift paddles or the parking brake. The control system synchronizes the information about the currently engaged gear stage with the current existing position of the operating element. In the event of a discrepancy between the predefined gear stage and the position of the operating element, the control system actuates the actuator to move the operating element into the predefined gear stage, referred to hereinafter as the shift position.

In the context of the invention, an automatic shift movement also includes a return of the operating element from a shift position just selected by the user into the shift position corresponding to the current gear stage, if a shift into the gear stage corresponding to the shift position selected by the user has not taken place. If, for example in a simulated H-shifter, the user moves the operating element from the shift position for the “forward gear 3” gear stage into the shift position for the “forward gear 2” gear stage, the control system can control the actuators so that the operating element provides haptic feedback for the duration of the manual user intervention, even if such a gear stage change does not take place due to impending overspeed. As soon as the user unblocks the operating element by releasing it, it becomes active as a result of the then automatically executed shift movement and is directed back into the shift position corresponding to the current gear stage, in this example the shift position “forward gear 2”.

In a monostable shift pattern, for example having a monostable selector lever as an operating element, the operating element returns automatically to the stable rest position after a manual deflection by the user, if the haptics of a conventional monostable shift pattern and the restoring forces acting on the operating element are replicated by the actuators. In a monostable shift pattern, an automatic shift movement occurs when a gear stage change takes place in the motor vehicle or in its transmission without user intervention on the operating element of the device and the monostable operating element undergoes an automatic movement out of its rest position to signal the gear stage change that is occurring.

In a further development of the invention it can be provided that different gear stages are associated with different shift positions of the operating element, wherein the shifting thresholds of adjacent shift positions are spaced apart from one another. It is thus possible to move the operating element out of the shift position up to a predetermined limit without shifting the gear stages. This is in particular advantageous if the user makes an imprecise or unintentional input to the operating element, for example, without intending a gear stage change.

In a further development of the invention it can alternatively be provided that the shifting thresholds define a gear range, which extends around the respective shift position of a gear stage and within which the operating element can be moved without triggering a gear stage control signal and the gear ranges of adjacent shift positions preferably overlap. Such an embodiment makes it possible to have both short shifting travel between the individual shift positions and large gear ranges. Low-error and also convenient operation is thus made possible.

Preferably, at least one position sensor for determining the pivot or rotational position of the operating element relative to the at least one axis of rotation and for producing a corresponding position signal can be provided. The position sensor detects the position of the operating element either continuously, at predefined intervals or upon separate activation, in order to report said position back to the control system of the device. For this purpose, the position sensor produces an analog or digital position signal, which is then processed by the control system connected to the position sensor. In versions of the device having multiple axes of rotation, the position sensor can determine the pivot or rotational position of the operating element relative to the at least one rotational position of the operating element. It is also conceivable for the position sensor to additionally detect said position relative to a second axis of rotation and communicate it to the control system.

In a variant of the invention, the position sensor can be disposed directly at or on the axis of rotation. In the context of the present invention, the term “axis of rotation” can refer to an axle component or a shaft, which is configured for the rotatable or pivotable mounting of the operating element on the device. An axis of rotation can also be a virtual axis, however, about which the operating element is rotatably or pivotably held with the aid of a bearing. The disposition of the position sensor directly at or on the axis of rotation makes it possible to determine the position of the operating element particularly accurately.

Alternatively, the position sensor can be disposed on the actuator in order to evaluate the movement produced by the actuator and, based on this, to infer the position of the operating element. To adjust the accuracy of the measurement on the actuator, an additional gearing, which transmits or reduces the movement produced directly by the actuator, can be provided on the actuator. A rotational movement of the actuator can be transmitted to increase the measurement resolution, for example, so that a rotation produced by the actuator is multiplied for the purpose of position measurement. This is in particular useful for relative measurement methods, in which the angle of rotation of the measuring transducers is not limited. A reduction of the movement produced by the actuator is useful if an absolute measurement method is used, in which the measurement transducer can only be moved over a limited angle or a limited distance.

According one embodiment of the invention, the control system can be configured for determining a shift position of the operating element and also for producing a control signal for the movement and/or haptic feedback of the operating element taking into account the position signal of the position sensor. The shift position is a position of the operating element which, in accordance with the shift pattern currently being used, corresponds to a specific gear stage or a specific gear stage change. This makes it possible to simplify the device in such a way that multiple functions of the device can be performed at the same time with little metrological effort. A separate sensor system to determine the engaged gear stage, for example, or a special sensor system to produce the haptics, is therefore unnecessary.

The at least one actuator can preferably be configured as an electric motor, for example as a DC motor. BLDC motors are particularly preferred. BLDC stands for “Brushless Direct Current”. Such motors are characterized by an armature having a permanent magnet surrounded by fixed stator coils which are operated with direct current. To operate the motor, a so-called “commutation” of the direct current is required, i.e. the controlled or regulated wiring of the stator coils using direct current with a predefined clock rate. The clock rate is dependent on the rotational position of the armature within the motor and on the desired size of the movement or force to be produced at the armature. BLDC motors are also particularly well suited for producing torque when the engine is stationary. It has therefore been shown that this motor type is particularly well suited for producing virtual detents, virtual stops, virtual mechanical resistances, virtual guides and virtual gates.

In one particular embodiment of the invention, it can also be provided that the actuator is configured as a BLDC motor and the control system is configured for producing a commutation signal for the BLDG motor taking into account the position signal of the position sensor. The position signal of the position sensor can thus actually be used in three ways, so that a separate sensor for detecting the armature position of the BLDG motor for commutation purposes can be omitted.

The invention can also provide for the operating element to be connected to the axis of rotation. This makes it possible to simplify the design of the device, because complex bearing arrangements are largely unnecessary. Such an embodiment is in particular suitable for devices having only one axis of rotation, such as rotatory gear stage selection devices.

The haptic feedback in the device can at least include “force feedback”, i.e. the production of a counterforce to the manual user input, and/or vibration and/or at least one virtual limit stop and/or a virtual lateral guide and/or a virtual gate guide and/or an emulated detent. A conventional, mechanical shifter can thus be simulated realistically, whereby the user inputs by adjusting the operating element affect the actual gear stage of the vehicle only if specific safety criteria have also been met. Said criteria can, for example, include a predetermined speed or rpm range for changing the gear stage. If one or more of the safety criteria are not met, the device can immediately report this back to the user by means of haptic feedback. For example, if the rpms are too high for a gear stage change, a vibration can be created by the operating element to inform the user that the desired gear stage change is not possible or is being prevented for safety reasons. In addition, by creating a virtual limit stop, it is possible to prevent the user from engaging a particular shift position, thus informing him that the desired shifting is not taking place.

Virtual lateral guides and virtual gate guides make it possible to provide the user with different shift patterns, for example an H-shifting gate or a monostable operating element that automatically returns to a rest position after a shift position is selected. An emulated detent provides the user with haptic feedback about the actual position of the operating element, so that a desired selection of a gear stage can also be performed blind.

When the haptic feedback is realized as a vibration of the operating element, it can be provided that the vibration takes place about at least one axis of rotation of the device. The amplitude of the vibration is produced at a contact surface of the operating element intended for the user and covers a predetermined arc length. This arc length is preferably in the range of approximately 0.2 mm to approximately 0.5 mm, in particular at approximately 0.3 mm. The vibration frequency of such a vibration can preferably be between 5 Hz and 100 Hz, preferably between 20 Hz and 30 Hz. It has been shown that vibrations with the aforementioned parameters can be felt particularly well by the human hand and differ sufficiently from the other vibrations that typically exist in a moving or running vehicle, so that the vibration feedback is not, or only rarely, confused with another oscillation occurring in the vehicle.

The operating element can preferably be configured as a selector lever and/or as a rotary knob. Selector levers mimic the devices known from conventional vehicles for selecting gear stages, such as gearshift levers, particularly well, so that it does not take long at all for the user to get used to them. Rotary knobs, on the other hand, can be fitted into the dashboard of a vehicle in a particularly space-saving manner.

According to one variant of the invention, the operating element can be configured as a selector lever that is pivotable or rotatable about two axes of rotation, whereby the axes of rotation extend substantially perpendicular to one another, preferably intersect in substantially perpendicular manner. The selector lever can thus be moved in two spatial directions and assume a wide range of different positions, so that two-dimensional shift patterns such as an H-shifter or an automatic shift pattern with a separate tapping channel can be replicated.

It can preferably be provided that exactly only one actuator is assigned to each axis of rotation, so that all functions for exerting a force on the operating element around the respective axis are combined onto one actuator. This simplifies the design of the device, as a result of which it is easier to control and also more cost-effective.

It can preferably be provided that the actuator of the one axis of rotation can be controlled in dependence of the position of the operating element with respect to the other axis of rotation and/or the actuator of the other axis of rotation can be controlled in dependence of the position of the operating element with respect to the one axis of rotation. Such an embodiment makes it particularly easy to create virtual lateral guides and/or virtual gates and/or virtual detents.

With regard to the shifting thresholds already described above, it can be provided that the overlap of the gear ranges of adjacent shift positions is approximately ¼ to ½, preferably ⅜ of the width of a gear range. This results in a particularly good compromise between the maximum deflection of the operating element from the shift position without a gear stage change and the length of the shifting travel to the next shift position.

In one variant of the invention, the device can comprise a sensor, for example a touch sensor, which is connected to the control system, detects a manual intervention by the user and sends a corresponding signal to the control system. This permits the detection of additional information as to whether the user is taking hold of the operating element. Based on this information, it is possible to switch to a manual shift mode even before a discrepancy between the target position of the operating element and the detected actual position occurs.

Based on the above-described disadvantages, a further object of the invention is to provide an improved method for selecting gear stages that allows more reliable shifting between individual gear stages than the state of the art.

This object is achieved with a method for selecting gear stages in motor vehicles according to Claim 21. The method is carried out using a device according to any one of Claims 1 to 20 and is characterized in that the different gear stages are associated with different shifting thresholds of the operating element for shifting into another gear stage and the control system initiates a gear stage change as soon as a shifting threshold is exceeded in the direction of the shift position associated with it. This ensures that shifting into a different gear stage is reliable when the user changes the gear stage manually. Shifting from a first into a second gear stage thus takes place at a different position of the operating element than shifting from the second gear stage into the first. There is therefore always the existence of a particular state and, if the operating element is located at the transition between two adjacent positions that are assigned to different gear stages, a so-called transient oscillation between two selectable gear stages is avoided.

In further development of the method it can be provided that, when the operating element is moved manually by a user, the actuator produces a variable restoring force which, as force feedback, is opposite to an adjusting force introduced into the operating element by the user. On the one hand, the force feedback can signal to the user that a virtual end position at a virtual limit stop has been reached. A virtual detent can alternatively or additionally be produced with the aid of the restoring force, by modulating, i.e. increasing or decreasing, the restoring force in such a way that the user gets the haptic impression that the operating element is moving over a mechanical detent having a number of monostable stops. Additionally or alternatively, the restoring force can be set such that it increases as the deflection of the operating element increases. Therefore, if the progression of the force increase is approximately linear, the function of a mechanical restoring spring that deforms according to Hooke's law can be replicated. A combination of these sub-functions is possible as well. For example, a monostable operating element having an approximately linearly increasing restoring force can be replicated and additionally overlaid with a virtual detent.

Correspondingly, it can be provided that the restoring force is a function of the position of the operating element. Both the amount and the direction of the restoring force can be controlled or regulated as a function of the position. In the simple case of replicating a restoring spring as a virtual restoring spring, the restoring force increases with an increasing deflection of the operating element. In the more complex replication of a detent as a virtual detent, the replication of a longitudinal guide as a virtual longitudinal guide or the replication of a gate as a virtual gate, the amount and direction of the restoring force are controlled or regulated as a function of the position in such a way that the operating element remains at a specific position or in a specific position range despite the application of an adjusting force by the user.

It can additionally be provided that the actuator causes a vibration of the operating element about the at least one axis of rotation or one of the axes of rotation in dependence of the position of the operating element. In addition to the haptic feedback, this makes it possible to produce a haptic signal by means of a restoring force, through which the user can be informed of a particular state of his vehicle. It is thus possible to vibrate the operating element when a rpm limit is reached, or when getting close to an inadmissible shift position. The inadmissible attempt to engage the parking brake of an automatic transmission while driving, for example, can be signaled to the user by a vibration.

According to a further development of the invention it can be provided that the actuator moves the operating element into a predetermined position. The method has the advantages described in connection with the device, in which the operating element can be configured for manual actuation by the user and also for an automatic shift movement by the actuator actuated by the control system.

It can in particular be provided that the predetermined position corresponds to a gear stage or a gear stage change, in particular an automatically engaged or predefined gear stage.

Further objectives, advantages, features and possible applications of the present invention will emerge from the following description of a design example on the basis of the drawing. All described and/or depicted features alone or in any useful combination form the subject matter of the present invention, irrespective of the combination in the claims or the dependence thereof.

### DESCRIPTION OF THE DRAWINGS

The Figures show, in part schematically:

FIG. 1 a rotary actuator disposed in the interior of a motor vehicle,

FIG. 2a a selector lever disposed in the interior of the motor vehicle,

FIG. 2b a shift diagram and a navigation map shown on a display,

FIG. 3 a detail view of the selector lever, which can be pivoted about a single axis, including the bearing and the drive,

FIG. 4 a detail view of the selector lever, which can be pivoted about two axes of rotation,

FIG. 5 a further detail view according to FIG. 4,

FIG. 6 a further detail view according to FIG. 4,

FIG. 7 a detail view of a reduction gear having a position sensor and disposed on the actuator,

FIG. 8 a block diagram of the global control algorithm implemented in the control system,

FIG. 9 a schematic illustration of a virtual gate guide in the manner of an H-shifter,

FIG. 10 an illustration of single shift lane of a virtual gate guide,

FIG. 11 an illustration of an attempt to make a prohibited gear stage change,

FIG. 12 an illustration of haptic feedback in the form of a vibration of the selector lever and

FIG. 13 a diagram of some shift positions in dependence of the position of the selector lever.

### DETAILED DESCRIPTION

In the following figures of the drawing, the same or similarly acting components are provided with the same reference signs on the basis of one embodiment in order to improve legibility.

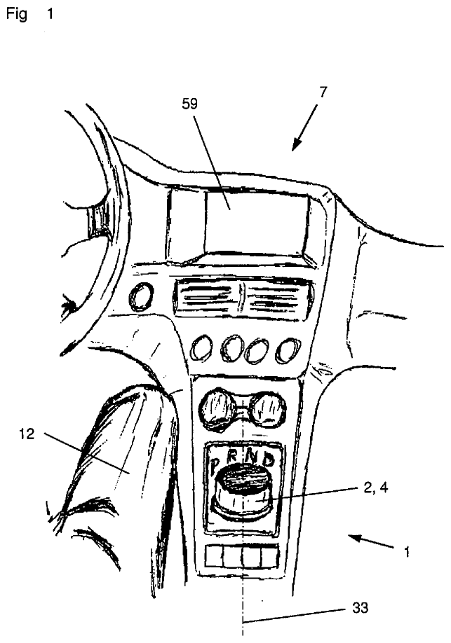

FIG. 1 shows a device 1 for selecting gear stages in motor vehicles 7. In this embodiment, an operating element 2 that selects the respective gear stage is configured as a rotary actuator, in particular as a rotary knob 4, which is rotatably disposed with respect to an axis of rotation 33. In the present case, the rotary knob 4 is located in the center console of the motor vehicle 7 so that it can be easily operated by a user 12. The axis of rotation 33 is aligned approximately parallel to the vertical axis of the motor vehicle 7, so that, in a seated body position with his elbow angled, the user 12 can grip the operating element laterally in such a way that the operating element 2 can be rotated with a simple movement of his hand. However, depending on the operating concept and the arrangement of the operating element 2 in the passenger compartment, it can also be provided that the axis of rotation 33 is inclined.

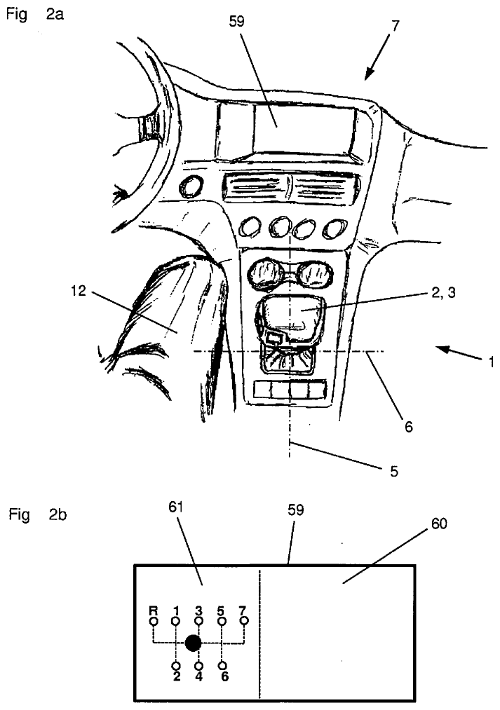

In an embodiment according to FIG. 2a, the operating element 2 is disposed in the center console of the motor vehicle 7 as a selector lever 3. In the present case, the selector lever 3 is rotatable or pivotable about the axes of rotation 5, 6. In the passenger compartment of the motor vehicle 7 there is also a display 59, which can show the user 12 specific, predefined or freely selectable information. In connection with the device 1, the display 59 can also display a shift diagram 61, from which the user 12 can see how to move the operating element 2 in order to select specific gear stages. An example of such a shift diagram 61 is shown in FIG. 2b. In addition to the shift diagram 61, the display 59 shows at least one other piece of information, for example a navigation map 60 of the vehicle navigation system.

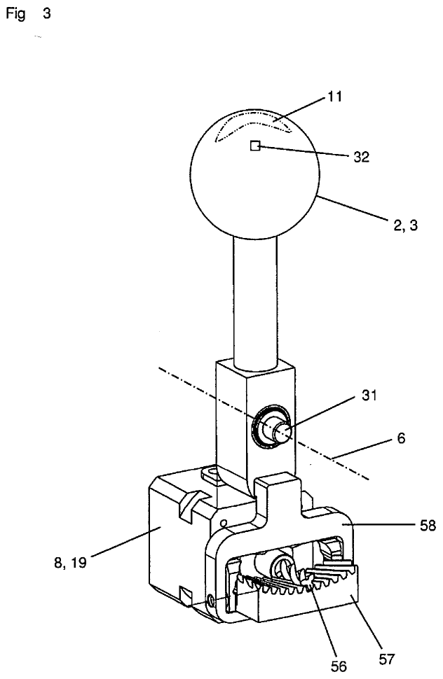

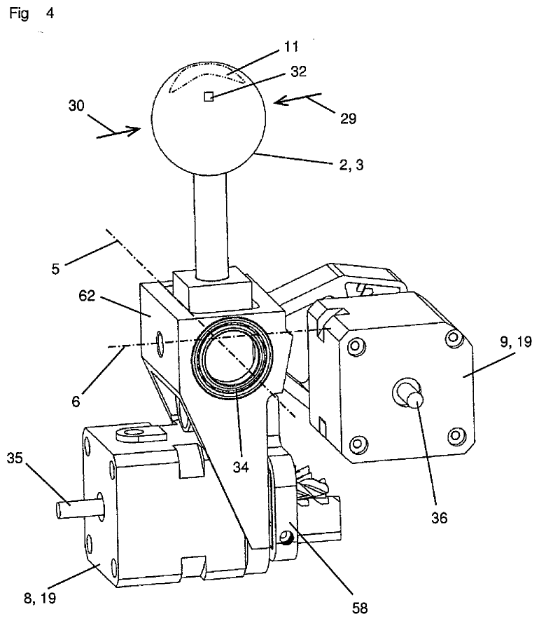

According to FIG. 3, it can alternatively be provided that the selector lever 3 is pivotable about only one axis of rotation 6. The axes of rotation 5, 6 can be virtual axes, whereby the selector lever 3 is movably guided by means of a bearing such that it is pivotable around the virtual axis 5, 6. As can be seen in FIG. 3 or FIG. 4, at least one of these axes of rotation 5, 6 can also coincide with a shaft 31, 34 on which the selector lever 3 is pivotably mounted.

The operating element 2 is mechanically operatively connected to at least one actuator 8, 9, which can be configured as an electric motor, in particular as a BLDG motor 19. In the present example according to FIG. 3, the actuator 8 is connected to the selector lever 3 in a torque-proof manner and engages with its output shaft 35 configured as a gear wheel 56 in a toothed ring gear segment 57. The ring gear segment 57 is stationarily fixed to a holder 58 in the vehicle 7 or inside a housing of the device 1, so that an actuation of the actuator 8 with an associated rotation of its gear wheel 56 causes both the selector lever 3 and the actuator 8 to pivot about the axis of rotation 6. The actuators 8, 9 can also comprise an engine shaft extension 35, 36 of the output shaft for picking up a movement of the engine.

According to the embodiment of the device 1 according to FIG. 4, the selector lever 3 is caused to pivot about two axes of rotation 5, 6 by two actuators 8, 9. One respective gear wheel 56, which engages in a respective associated toothed ring gear segment 57, is disposed on the output shaft of the actuator 8, 9. This ring gear segment 57 is connected to the operating element 2 via a holder 58. A pivoting or rotating movement of the operating element 2 is thus brought about by actuating and energizing the actuator 8, 9. In this design example according to FIG. 4, one of the actuators 9 remains stationary with respect to the not depicted housing of device 1 or stationary with respect to the motor vehicle 7, whereas the other actuator 8 is pivoted together with the operating element 2.

In order to determine whether the user 12 is touching the operating element 2, a touch sensor 32 disposed on a contact surface 11 of the operating element 2 can be provided. The contact surface 11 is the part of operating element 2 the user 12 touches, for example with his hand.

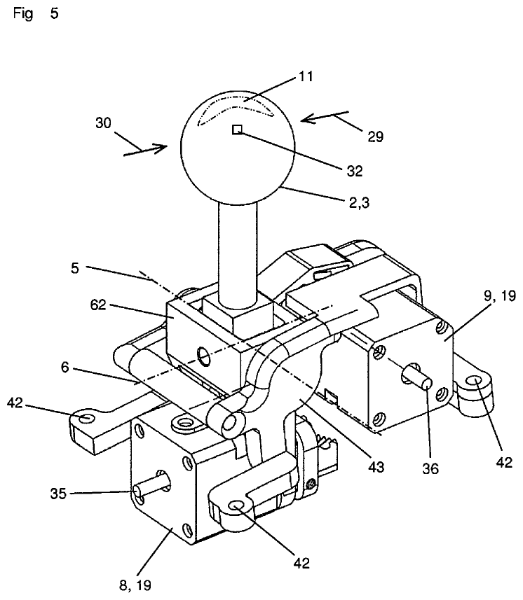

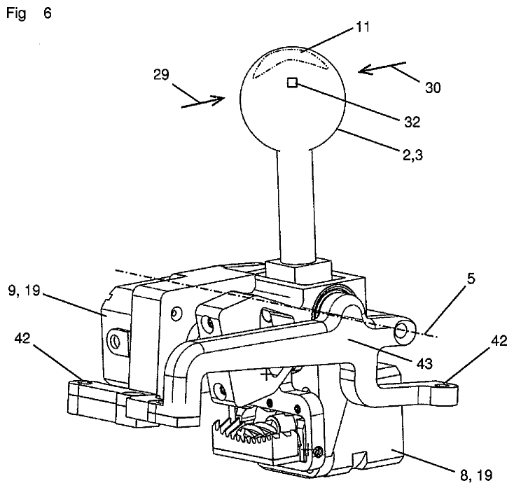

FIG. 4, FIG. 5 and FIG. 6 show that the device 1 comprises bores 42 for fixing the device 1 to the motor vehicle 7 by means of rivets, pins or screws. The actuators 8, 9 are operatively connected to the operating element 2 by means of a mounting bracket 43. The mounting bracket 43 itself is stationarily fixed to the not depicted housing of the device 1 or to the motor vehicle 7. A carrier 62 is mounted on the mounting bracket 43 so as to be rotatable about the first axis of rotation 5. To produce a rotation of the carrier 62 about the first axis of rotation 5, the carrier 62 is in operative connection with the actuator 9 that is stationarily fixed to the mounting bracket 43. The actuator 8, by means of which the selector lever 3 can be pivoted around the axis of rotation 6, is fixed to the carrier 62. The selector lever 3 is held in the carrier 62 so as to be pivotable about the axis of rotation 6 and in a torque-proof manner with respect to the axis of rotation 5. The selector lever 3 can thus pivot inside the carrier 62 about the axis of rotation 6, but can only pivot about the axis of rotation 5 together with the carrier 62 and the actuator 8.

Because the actuators 8, 9 can be controlled in dependence of the position 15 of the operating element 2 by means of a position signal 17 emitted by a position sensor 16, haptic feedback for the user 12 can be produced. A control system 14 for producing haptic feedback by means of an appropriate actuation of the actuators 8, 9 is provided. Based on the information about the position of the operating element 2 and/or other status information from the motor vehicle 7, haptic feedback can be provided to the user 12 via the operating element 2. Moreover, depending on the position change of the operating element 2 brought about by the user 12, the control system 14 can produce a gear stage control signal 25 that is output to a transmission or a transmission controller or to a gear stage controller to initiate a gear stage change.

It is also possible to use the control system 14 not only to actuate the actuator(s) 8, 9 for haptic feedback, but also to initiate an automatic shift movement of the operating element 2 on the basis of gear stage control signals 25 input to the control system 14.

During autonomous driving of the motor vehicle 7, for example, the actuator 8 actuated by the control system 14 can be used to automatically adjust the operating element 2 to the shift position 27 predefined by the autonomous drive control. The shift position 27 is a predetermined position of the operating element 2 that corresponds to a specific gear stage, such as P, R, N, D, 1-8, in the currently valid operating scheme for the operating element 2 or, in the case of monostable shift patterns, corresponds to a specific gear stage increase or decrease, such as +1, −1, +2, −2.

An automatic shift movement 27, for example, takes place in such a way that, when shifting from the gear stage “D”, for forward travel, into the gear stage “R”, for reverse travel, the operating element 2 of an autonomously guided vehicle is moved into the corresponding position without user intervention by an appropriate actuation of the actuator(s) 8, 9. This allows the user 12 in the motor vehicle 7 to infer the current driving status of the motor vehicle 7 from the visible or tactile position of the operating element 2.

As soon as the automatic shift movement 27 of the operating element 2 is interrupted due to an intervention by the user 12, haptic feedback can instantly be provided to the user 12.

In the context of the invention, an automatic shift movement 27 also includes a return of the operating element 2 from a different shift position 27 into the shift position 27 corresponding to the current gear stage, if a shift into the gear stage corresponding to the other shift position 27 has not taken place. If, for example in a simulated H-shifter, the user 12 moves the operating element 2 from the shift position 27 for the “forward gear 3” gear stage into the shift position 27 for the “forward gear 2” gear stage, the control system 14 can control the actuators 8, 9 so that the operating element 2 provides haptic feedback for the duration of the manual user intervention, even if such a gear stage change does not take place due to impending overspeed. As soon as the user 12 unblocks the operating element 2 by releasing it, it becomes active as a result of the automatically executed shift movement and is directed back into the shift position 27 corresponding to the current gear stage, in this example the shift position 27 “forward gear 2”.

The control system 14 synchronizes the information about the currently engaged gear stage or shift position 27 with the current existing position 15 of the operating element 2. In the event of a discrepancy, the control system 14 actuates the actuator 8, 9 to move the operating element 2 into the predefined shift position 27.

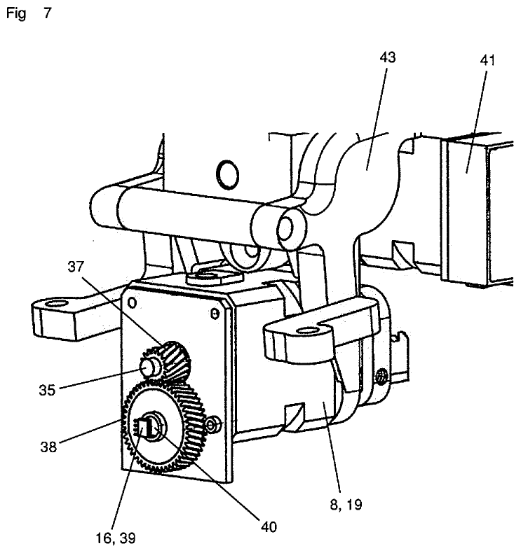

According to FIG. 7, the position sensor 16 is disposed on the actuator 8 to evaluate the movement produced by said actuator. Within the context of the invention, it is conceivable that such a position sensor 16 is also disposed on the other actuator 9. A reduction gear is provided to improve the accuracy of the measurement, whereby, in the present case, a reduction gear 38 meshes with a pinion 37 disposed on the engine shaft extension 35 of the actuator 9. The sensor 39 is disposed on the shaft of the reduction gear 38 and, in the present case, is configured as a Hall sensor which evaluates the rotation of a permanent magnet 40 connected to the engine shaft extension 35. The sensor 39 and the reduction gear are respectively mounted in a housing 41. Instead of being a Hall sensor, the sensor 39 can also work on the basis of other measuring principles. In particular other magnetic measurement methods, optical, acoustic, mechanical or capacitive measurement methods, which record the rotation of the engine shaft extension 35 within the context of a relative or absolute measurement, are conceivable as well. Due to the mechanical operative connection between the engine output shaft and the operating element 2 and the underlying kinematics, the position of the operating element 2 can be determined by calculation in the control system 14.

When using a sensor 35 according to the principle of an absolute measurement method, the measurable angle of rotation can be limited, for example to exactly one revolution. The reduction ratio between the pinion 37 and the reduction gear 38 can then be selected such that the reduction gear 38 rotates about itself no more than once or less than once between the opposite end positions of the operating element 2.

When using a sensor 35 according to the principle of a relative, incremental measurement method in which only individual measuring steps are counted, the transmission ratio between the pinion 37 and the reduction gear 38 can also be implemented as a multiplication in order to increase the resolution of the measurement.

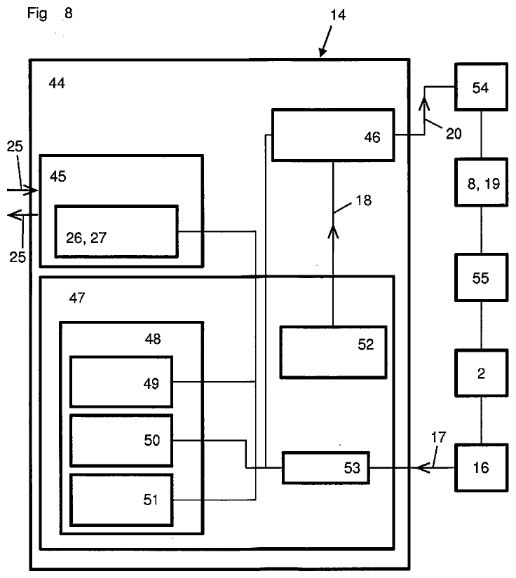

FIG. 8 schematically shows the global control algorithm 44 implemented in the control system 14 in interaction with the other components of device 1. As shown on the right side in FIG. 8, the control system 14 is connected within the device with the engine power electronics 54 as well as with a position sensor 16, for example with the sensor 39. Also provided in the control system 14 is a software and/or hardware-implemented module 45, which sends gear stage control signals 25 to a higher-level controller of the motor vehicle 7 or to the transmission or receives gear stage control signals 25 from said controller or transmission.

The engine power electronics 54 are connected to the actuator(s) 8, 9. In the present design example, both actuators 8, 9 are designed as a BLDC motor 19 and connected to the operating element 2. A gearing 55, which in this example is configured as a gear wheel 56 and an internally toothed ring gear 57, can provide a reduction or a multiplication of the movement of the actuator as shown in FIGS. 2 to 7. The position of the operating element 2 is detected by the position sensor 16, which emits a position signal 17 associated with the position. The position signal 17 is entered into the control system 14 and is converted there, in a software and/or hardware-implemented module 53, to an actual position. As can be seen from the connecting lines in FIG. 8, the determined actual position is sent to module 45 in order to produce the gear stage control signal 25.

At the same time, the actual position 53 is sent to a lower-level control algorithm 47 for the control of the haptics. The control algorithm 47 includes three software and/or hardware-implemented modules 49, 50, 51, for example, which are used to produce target value components for the return, vibration and detent of the operating element 2.

Module 49 produces a target value component for the position of the operating element 2 that is required to effect a return of the operating element 2 to a predefined position. This serves to replicate a mechanical return spring, for example, or to produce a force feedback effect, for example having an increasing adjusting force. Module 49 can also be used to realize a virtual gate or longitudinal guide, for example to hold a selector lever 3 within a simulated shift lane by means of laterally sharply increasing restoring forces.

Module 50 produces a target value component for the position of the operating element 2 that is required to effect a vibration of the operating element 2. This serves to produce perceptible haptic feedback to signal a not foreseen user action, for example, or a suggestion to shift at a rpm limit of the vehicle engine.

Module 51 produces a target value component for the position of the operating element 2 that is required to produce a virtual detent.

The target value components produced by, modules 49, 50 and 51 are used in a higher-level software and/or hardware-implemented module 48 to calculate a target value specification. In a higher-level software and/or hardware-implemented module 52, the target value specification is compared with the actual position and, taking into account control parameters, used to calculate a control variable in the form of a control signal 18. The actual position detected by the position sensor 16 is thus used multiple times.

In a not depicted simple variant of the invention, in which the actuators 8, 9 are not configured as BLDCs but rather as brushed motors, the control signal 18 is sent directly to the engine power electronics 54 to control the actuators 8, 9.

In the present example with BLDC motors 19, the engine power electronics 54 are not controlled directly with the control signal 18 but rather with a commutation signal 20 produced from said control signal. This is because the coils disposed on the stator in a BLDC motor are controlled in a specific sequence and with a specific cycle to actuate the motor. The cycle and the sequence are directly dependent on the rotational position of the rotor that is provided with a permanent magnet. Therefore, to produce the commutation signal 20, both the control signal 18 and the actual position of the operating element 2 determined in module 53 are used in the software and/or hardware-implemented module 46, because the latter is directly and firmly kinematically related to the rotor position. This means that, in the present design example, the position signal 17 of the position sensor 16 is used three times, namely to evaluate and produce the gear stage control signal 25, to produce the haptics and to produce the commutation signal 20.

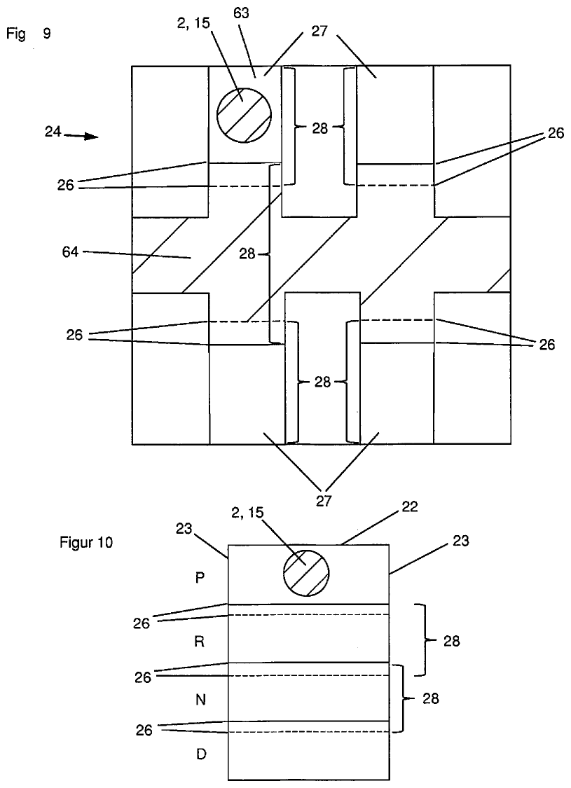

FIG. 9 shows a virtual gate guide 24. In the design example selected here, which is in the manner of an H-shifter, a total of five shift positions 27 in virtual shift lanes are provided. Each of these shift positions 27 involves a different shifting threshold 26 of the operating element 2 for shifting into a different gear stage or shift position 27. The shifting thresholds 26 define a gear range 28, which extends around the respective shift position 27 of a gear stage and within which the operating element 2 can be moved without triggering a gear stage control signal 25.

In the present example according to FIG. 9, the operating element 2 is in the upper left position, which, in a conventional H-shifter, corresponds to the shift position 63 “forward gear 1”. In the event of a gear stage change, the operating element 2 has to be moved from its assigned shift position 63 “forward gear 1” over the shifting threshold 26 illustrated by the solid line and beyond the dashed line. When crossing the shifting threshold 26 illustrated by the dashed line, the adjacent shift position 64 “neutral” is assigned to the operating element 2 and a corresponding gear stage control signal 25 is emitted. In the opposite direction, however, the operating element 2 has to be moved across the shifting threshold 26 illustrated as a solid line in the direction of the shift position 63, in order to achieve a reassignment of the shift position 63. The gear ranges 28 of the shift positions 63 and 64 therefore overlap and each shift position 27 has a different shifting threshold 26.

As an example, the different shift positions 27 in FIG. 10 are identified with the letters “P, R, N, D” and are guided in a single shift lane of a virtual gate guide 24. There is one shifting threshold 26 for each gear stage change, whereby the shifting thresholds 26 illustrated with the solid line apply for shifting in the direction of the shift position “P”. The shifting thresholds 26 respectively illustrated with a dashed line apply for shifting the shift positions 27 in the direction of the shift position “D”. The overlap of the gear ranges 28 is shown in FIG. 10 as an example.

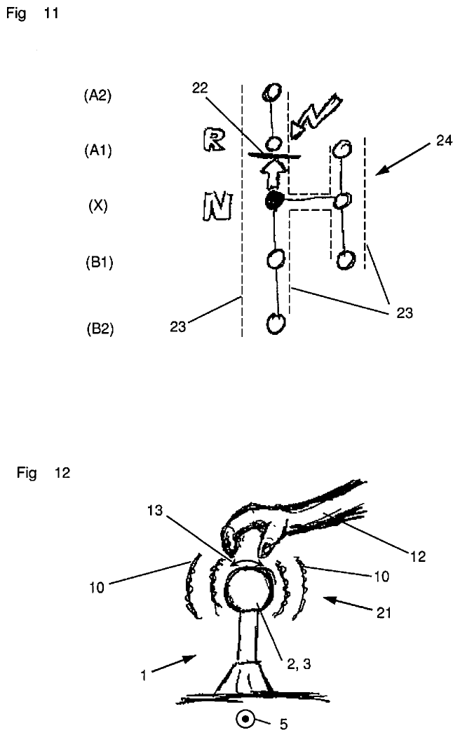

FIG. 11 schematically shows the attempt to make a prohibited gear stage change from the neutral position into the reverse gear. If an engagement of the reverse gear is not permitted while the vehicle is moving forward, the device 1 simulates a virtual limit stop 22 which prevents the user 12 from reaching the shift position “R”. Since the operating element 2 cannot move sideways due to the presence of virtual lateral guides 23 and the virtual limit stop 22 restricts the possible movement of the operating element 2 as well, the user 12 can only move the operating element 2 back into the shift position “N”. At the same time, the user can be notified of the prohibited gear stage change by means of haptic feedback in the form of a vibration 21.

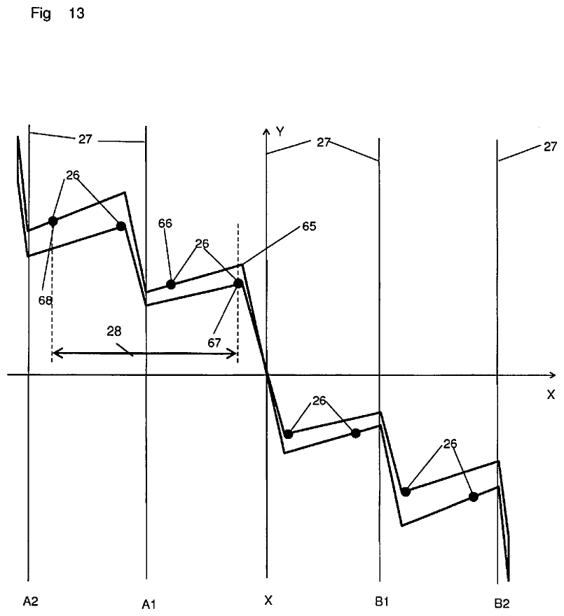

FIG. 12 shows the operating element 2 configured as a selector lever 3, which provides haptic feedback to the hand of the user 12 by carrying out a vibrational movement about the axis of rotation 5. In doing so, the selector lever 3 pivots around the axis of rotation 5 with a frequency that is clearly felt by the human hand. The vibration frequency can be between 5 Hz and 100 Hz, preferably between 20 Hz and 30 Hz. The amplitude 10 of the vibration 21 at the contact surface 11 of the operating element 2 covers a predetermined arc length 13, which is within the range from approximately 0.2 mm to approximately 0.5 mm. The vibration 21 can simultaneously or alternatively also take place around the axis of rotation 6.

FIG. 13 schematically shows a diagram of the progression of the adjusting force 30 and the opposite restoring force 29, whereby the pivot angle of the operating element 2 is plotted on the X-axis and the restoring force 29 applied by the device 1 is plotted on the Y-axis. FIG. 13 shows the force progression, the shift positions 27 and the shifting thresholds 26 for a monostable operating element 2, which can be deflected from its stable center position “X” in two directions to the shift positions 27. An increment or decrement by one gear stage is assigned to a deflection to the shift positions “A1” or “B1”, and an increment or decrement by two gear stages is assigned to the shift positions “A2” or “B2”. The force progression of the restoring force 29 on the operating element 2 simulates a detent and a restoring spring coupled to the operating element 2. The function of the restoring spring can be identified by the generally identifiable linear progression with a negative gradient, as a result of which the restoring force is positive for negative angles of rotation and negative for positive angles of rotation. This is overlaid with a jagged force progression which simulates moving over a virtual detent. The force progression is also subject to a hysteresis, as a result of which, when the operating element 2 is manually deflected by the user 12, the restoring force 29 follows the curve that is higher in accordance with the amount in Y-direction. In the opposite direction, the restoring force is reduced and follows the curve that is lower in accordance with the amount in Y-direction. This ensures a smoother return movement of the operating element 2 to the stable starting position “X”.

To detect the selection of an increment, for example according to shift position 27 “A1”, starting from the rest position “X”, the operating element 2 is moved in the direction of the shift position A1 and passes over a first maximum 65 in the force progression, which signals to the user 12 that the shift position 27 “A1” will be reached soon. Shortly before reaching the shift position 27 “A1”, the operating element 2 moves over the shifting threshold 26 at position 66. Since the shift position 27 “X” was previously assigned to the operating element 2, the assignment is now changed to shift position 27 “A1”. The operating element 2 can now be moved into the gear range 28 between positions 67 and 68, and the shifting thresholds 26 assigned to these positions, without changing the assignment from A1 to X or from A1 to A2. However, when the shifting thresholds 26 at positions 67 and 68 are reached, the assignment is shifted to “X” or A2.

As a result of the restoring force 29 increasing in positive and negative X direction and the overlaid virtual detent, the user 12 receives haptic feedback about the position of the operating element 2 and the associated shift position 27.

The present invention is not restricted in terms of its configuration to the embodiments presented here. Rather, several variants are conceivable which make use of the solution presented here, even in the case of other types of configurations. It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

List of reference signs

| | |
|---|---|
| 1 | Gear stage selection device |
| | for a motor vehicle |
| 2 | Operating element |
| 3 | Selector lever |
| 4 | Rotary knob |
| 5 | Axis of rotation |
| 6 | Axis of rotation |
| 7 | Motor vehicle |
| 8 | Actuator |
| 9 | Actuator |
| 10 | Amplitude |
| 11 | Contact surface |
| 12 | User |
| 13 | Arc length |
| 14 | Control system |
| 15 | Position of the operating element |
| 16 | Position sensor |
| 17 | Position signal |
| 18 | Control signal |
| 19 | BLDC motor |
| 20 | Commutation signal |
| 21 | Vibration |
| 22 | Virtual limit stop |
| 23 | Virtual lateral guide |
| 24 | Virtual gate guide |
| 25 | Gear stage control signal |
| 26 | Shifting threshold |
| 27 | Shift position |
| 28 | Gear range |
| 29 | Restoring force |
| 30 | Adjusting force |
| 31 | Shaft |
| 32 | Touch sensor |
| 33 | Axis of rotation |
| 34 | Shaft |
| 35 | Engine shaft extension |
| 36 | Engine shaft extension |
| 37 | Pinion |
| 38 | Reduction gear |
| 39 | Sensor (Hall sensor) |
| 40 | Permanent magnet |
| 41 | Sensor housing |
| 42 | Bore |
| 43 | Mounting bracket |
| 44 | Control algorithm shifter |
| 45 | Module |
| 46 | Module |
| 47 | Control algorithm haptics |
| 48 | Module |
| 49 | Module |
| 50 | Module |
| 51 | Module |
| 52 | Module |
| 53 | Module |
| 54 | Engine power electronics |
| 55 | Gearing |
| 56 | Gear wheel |
| 57 | Ring gear segment |
| 58 | Holder |
| 59 | Display |
| 60 | Navigation map |
| 61 | Shift diagram |
| 62 | Carrier |
| 63 | Shift position “forward gear 1” |
| 64 | Shift position “neutral” |
| 65 | Maximum |
| 66 | Position |
| 67 | Position |
| 68 | Position |

1. A device (1) for selecting gear stages in motor vehicles (7), comprising:
an operating element (2) which selects the respective gear stage and is configured to be manually pivotable or rotatable with respect to at least one axis of rotation (5, 6);
an actuator (8) that acts upon the operating element (2) and that is configured to generate haptic feedback for a user; and
a control system (14) which actuates the actuator (8) and generates gear stage control signals (25) in dependence of the position (15) of the operating element (2), wherein the different gear stages are associated with different shifting thresholds (26) of the operating element (2) for shifting into another gear stage.

2. The device (1) for selecting gear stages in motor vehicles (7) according to claim 1, wherein the operating element (2) is configured both for manual actuation by the user (12) and also for an automatic shift movement by the actuator (8) actuated by the control system (14).

3. The device (1) for selecting gear stages in motor vehicles (7) according to claim 1 wherein the different gear stages are associated with different shift positions (27) of the operating element (2), and wherein the shifting thresholds (26) of adjacent shift positions (27) are spaced apart from one another.

4. The device (1) for selecting gear stages in motor vehicles (7) according to claim 1, wherein the shifting thresholds (26) define a gear range (28), which extends around the respective shift position (27) of a gear stage and within which the operating element (2) can be moved is movable without triggering a gear stage control signal (25), and wherein the gear ranges (28) of adjacent shift positions (27) overlap.

5. The device (1) for selecting gear stages in motor vehicles (7) according to claim 1, further comprising at least one position sensor (16) configured for determining the pivot or rotational position of the operating element (2) relative to the at least one axis of rotation (5, 6) and configured for producing a corresponding position signal (17).

6. The device (1) for selecting gear stages in motor vehicles (7) according to claim 5, wherein the position sensor (16) is disposed directly at or on the axis of rotation (5, 6).

7. The device (1) for selecting gear stages in motor vehicles (7) according to claim 5, wherein the position sensor (16) is disposed on the actuator (8).

8. The device (1) for selecting gear stages in motor vehicles (7) according to claim 5, wherein the control system (14) is configured for determining a shift position of the operating element (2) and also for producing a control signal (18) for the movement and/or haptic feedback of the operating element (2) taking into account the position signal (17) of the position sensor (16).

9. The device (1) for selecting gear stages in motor vehicles (7) according to claim 1, wherein the at least one actuator (8) is configured as an electric motor.

10. The device (1) for selecting gear stages in motor vehicles (7) according to claim 5, wherein the actuator (8) is configured as a BLDC motor (19) and the control system (14) is configured for producing a commutation signal (20) for the BLDC motor (19) taking into account the position signal (17) of the position sensor (16).

11. The device (1) for selecting gear stages in motor vehicles (7) according to claim 1, wherein the operating element (2) is connected to the axis of rotation (5, 6).

12. The device (1) for selecting gear stages in motor vehicles (7) according to claim 1, wherein the haptic feedback at least includes feedback selected from the group consisting of: force feedback, vibration (21), at least one virtual limit stop (22), and/or a virtual lateral guide (23), and/or a virtual gate guide (24), an emulated detent, and a combination of one or more of the foregoing.

13. The device (1) for selecting gear stages in motor vehicles (7) according to claim 1, wherein the haptic feedback includes a vibration of the operating element (2) about at least one axis of rotation (5, 6), wherein, on a contact surface (11) of the operating element (2) provided for the user (12), the amplitude (10) of the vibration has an arc length (13) of approximately 0.2 mm to approximately 0.5 mm.

14. The device (1) for selecting gear stages in motor vehicles (7) according to claim 1, wherein the haptic feedback includes a vibration of the operating element (2) having a vibration frequency between 5 Hz and 100 Hz.

15. The device (1) for selecting gear stages in motor vehicles (7) according to claim 1, wherein the operating element (2) is configured either as a selector lever (3) and/or as a rotary knob (4).

16. The device (1) for selecting gear stages in motor vehicles (7) according to claim 1, wherein the selector lever (3) is configured to be pivotable or rotatable about two axes of rotation (5, 6), and wherein the axes of rotation (5, 6) extend substantially perpendicular to one another.

17. The device (1) for selecting gear stages in motor vehicles (7) according to claim 1, wherein only one actuator (8, 9) is assigned to each axis of rotation (5, 6).

18. The device (1) for selecting gear stages in motor vehicles (7) according to claim 17, wherein the actuator (8) of the one axis of rotation (6) is controllable in dependence of the position (15) of the operating element (2) with respect to the other axis of rotation (5) and/or the actuator (9) of the other axis of rotation (5) is controllable in dependence of the position (15) of the operating element (2) with respect to the one axis of rotation (6).

19. The device (1) for selecting gear stages in motor vehicles (7) according to claim 4, wherein overlap of the gear ranges (28) of adjacent shift positions (27) is approximately ¼ to ½ of the width of a gear range (28).

20. The device (1) for selecting gear stages in motor vehicles (7) according to claim 1, further comprising: a sensor (32), which is connected to the control system (14) that detects a manual intervention by the user (12) and sends a corresponding signal to the control system (14).

21. A method for selecting gear stages in motor vehicles (7) comprising a device (1) according to claim 1, wherein the different gear stages are associated with different shifting thresholds (26) of the operating element (2) for shifting into another gear stage and wherein the control system (14) initiates a gear stage change as soon as a shifting threshold (26) is exceeded in the direction of the shift position (27) associated with said operating element (2).

22. The method for selecting a gear stage of a motor vehicle (7) according to claim 21, wherein when the operating element (2) is moved manually by a user (12), the actuator (8) produces a variable restoring force (29) which, as force feedback, is opposite to an adjusting force (30) introduced into the operating element (2) by the user (12).

23. The method for selecting gear stages in motor vehicles (7) according to claim 22, wherein the restoring force (29) is a function of the position (15) of the operating element (2).

24. The method for selecting gear stages in motor vehicles (7) according to claim 21, wherein the actuator (8) causes a vibration of the operating element (2) about the at least one axis of rotation (5, 6) in dependence of the position (15) of the operating element (2).

25. The method for selecting gear stages in motor vehicles (7) according to claim 21, wherein the actuator (8) moves the operating element (2) into a predetermined position (15).

26. The method for selecting gear stages in motor vehicles (7) according to claim 25, wherein the predetermined position (15) corresponds to an automatically engaged or predefined gear stage.
